(19) United States
(12) Patent Application Publication
(10) Pub. No.: US 2009/0300020 A1
(43) Pub. Date: Dec. 3, 2009

(54) WIRELESS VIRTUAL STORAGE APPARATUS AND REMOTE FILE ACCESSING METHOD

(76) Inventors: Kuo Min CHEN, Hsinchu (TW); Hen Der Wueh, Hsinchu (TW); Qien Yan, Hsinchu (TW); Jin Sheng Shieh, Hsinchu (TW)

Correspondence Address: Muncy, Geissler, Olds & Lowe, PLLC, P.O. BOX 1364, FAIRFAX, VA, 22038-1364, US

(21) Appl. No.: 12/434,227

(22) Filed: May 1, 2009

(30) Foreign Application Priority Data
Jun. 2, 2008 (TW) 97120519

(51) Int. Cl. G06F 17/30; G06F 15/16; G06F 12/06; G06F 13/20; H04L 9/32; G06F 21/00

(52) U.S. Cl. 707/9; 709/217; 711/173; 710/300; 726/5; 707/10; 707/E17.032; 726/17; 711/E12.103; 711/E12.091; 711/E12.002

(57) ABSTRACT

A wireless virtual storage apparatus and a remote file accessing method are utilized for a multimedia electronic device accessing remote files in a remote database. The apparatus includes a wireless network interface, microprocessor, and bus interface. The microprocessor runs a file system program, so as to create a virtual partition. Then the processor connects to a removable storage media reader of the multimedia electronic device via the bus interface, and the virtual partition is mounted by the multimedia electronic device. The microprocessor logs in the remote database via the wireless network interface, and creates virtual files in the virtual partition corresponding to the remote files. When the multimedia electronic device accessing the virtual files, the microprocessor loads the remote files from the remote database and changes the accessing path of the multimedia electronic device to the loaded remote files.

### CROSS-REFERENCES TO RELATED APPLICATIONS

This non-provisional application claims priority under 35 U.S.C. §119(a) on patent application Ser. No(s). 97/120,519 filed in Taiwan, R.O.C. on Jun. 2, 2008, the entire contents of which are hereby incorporated by reference.

### FIELD OF THE INVENTION

The present invention relates to remote file accessing, and more particularly to a wireless virtual storage apparatus and a remote file accessing method.

### BACKGROUND

Multimedia electronic devices, such as digital photo frame, multimedia television, and multimedia player, have data file browsing and specifically formatted file executing functions. Taking a digital photo frame as an example, the digital photo frame may browse files in a built-in or external memory through a built-in multimedia program. And then the digital photo frame displays a file list by a table or a graph. According to the selection of the user, the digital photo frame loads and executes the selected files with the multimedia program, so as to display a static picture, or display movie segments, or play music. In general, the built-in memory of the aforementioned multimedia electronic device is flash memory. An external removable storage media used as an external memory can be connected to the multimedia electronic device to further expand the storage capacity of the built-in memory if it is not insufficient. The external removable storage media may be a secure digital card (SD Card), a compact flash card (SF Card), a USB flash disk, or a memory stick.

Current removable storage media such as the USB flash disk is connected to the USB port of the multimedia electronic device through a USB connector. The removable storage media is formatted into one or more partitions. After the removable storage media is connected to the multimedia electronic device, the multimedia electronic device mounts the partitions under the file system thereof accesses the files in the partitions directly. However, the storage capacity of the removable storage media is limited, and many people are used to storing their multimedia files such as pictures, movie segments, and music segments in a remote database, such as Web album, Internet blog, or Internet file storage. To most multimedia electronic device, software and hardware resources of the multimedia electronic device can not be modified or upgraded. That is, adding a network interface or software to allow the multimedia electronic device to access the data in the remote database directly is impossible. If the multimedia electronic device has to process these remote files, the user has to use a network connected computer to download these remote files and stores these files in a removable storage media. And then connect the removable storage media to the multimedia electronic device. The aforementioned steps are very tedious, and the storage capacity of the removable storage media has to be large enough or the removable storage media has to be replaced continuously if the number of the object files is too great; it is very inconvenient for the user.

### SUMMARY OF THE INVENTION

To solve the aforementioned problems, an object of the present invention is to provide a wireless virtual storage apparatus and a remote file accessing method. The present invention ensures that a multimedia electronic device without an Internet function can be connected to a network to access the remote files stored in a remote database through a removable storage media reader.

To achieve the object, a wireless virtual storage apparatus is provided for connecting to a removable storage media reader of a multimedia electronic device, for the multimedia electronic device accessing at least one remote file in a remote database through a network, the wireless virtual storage apparatus, the wireless virtual storage apparatus includes a wireless network interface, a microprocessor and a bus interface. The wireless network interface uses a wireless network protocol to connect to a remote database via a network. The microprocessor runs a file system program, logs into the remote database through the wireless network interface, creates a virtual file corresponding to the remote file, and creates a virtual partition to store the virtual file. The bus interface is connected to the microprocessor and the removable storage media reader of the multimedia electronic device, to allow the multimedia electronic device to mount the virtual partition so as to access the virtual file. When the multimedia electronic device accesses the virtual file, the microprocessor loads the corresponding remote file from the remote database and changes an accessing path of the multimedia electronic device to the loaded remote file. Thereby, the multimedia electronic device accesses the remote files indirectly through the wireless virtual storage apparatus.

The present invention further provides a remote file accessing method, for a multimedia electronic device using a removable storage media reader to access at least one remote file stored in a remote database via a network. According to the method, after the multimedia electronic device is activated, the wireless virtual storage apparatus connects to the multimedia electronic device. Next, the wireless virtual storage apparatus loads a login profile, creates a virtual folder corresponding to the login profile, and stores the virtual folder in the virtual partition. After receiving an access request to the virtual folder from the multimedia electronic device, the wireless virtual storage apparatus logs in to the remote database in accordance with the login profile and then captures an accessible remote file list, so as to create a virtual file corresponding to the remote file in the virtual partition. After receiving the access request to the virtual file from the multimedia electronic device, the wireless virtual storage apparatus loads the remote file through a network and stores the remote file in a buffer. Then the wireless virtual storage apparatus changes an accessing path of the multimedia electronic device toward the loaded remote file stored in the buffer to answer the access request of the multimedia electronic device.

The present invention provides the virtual partition to be mounted by the multimedia electronic device. The access actions of the multimedia electronic device to the virtual partition are the same as the access actions of a general removable storage media without changing the original software and hardware functions of the multimedia electronic device. Therefore, the present invention achieves that the multimedia electronic device, which cannot be upgraded or connected to the network, to access the remote files, thereby removing the restriction on its storage capacity.

### BRIEF DESCRIPTION OF THE DRAWINGS

The present invention can be more fully understood by reference to the following description and accompanying drawings, in which:

FIG. 1 is a block diagram of an embodiment according to the present invention;

FIG. 2 is a schematic diagram, showing that a virtual partition corresponds to remote files through a network in the embodiment according to the present invention;

FIG. 3 is a schematic diagram, showing that a virtual partition is connected a plurality of remote database through a network in the embodiment according to the present invention; and

FIG. 4 is a flow chart, showing a method of the embodiment according to the present invention.

### DETAILED DESCRIPTION OF THE PREFERRED EMBODIMENTS

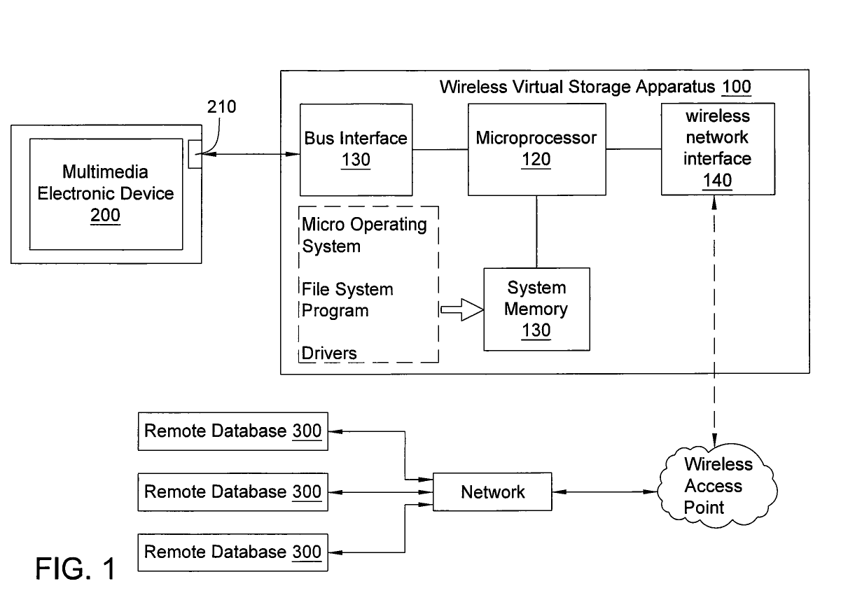

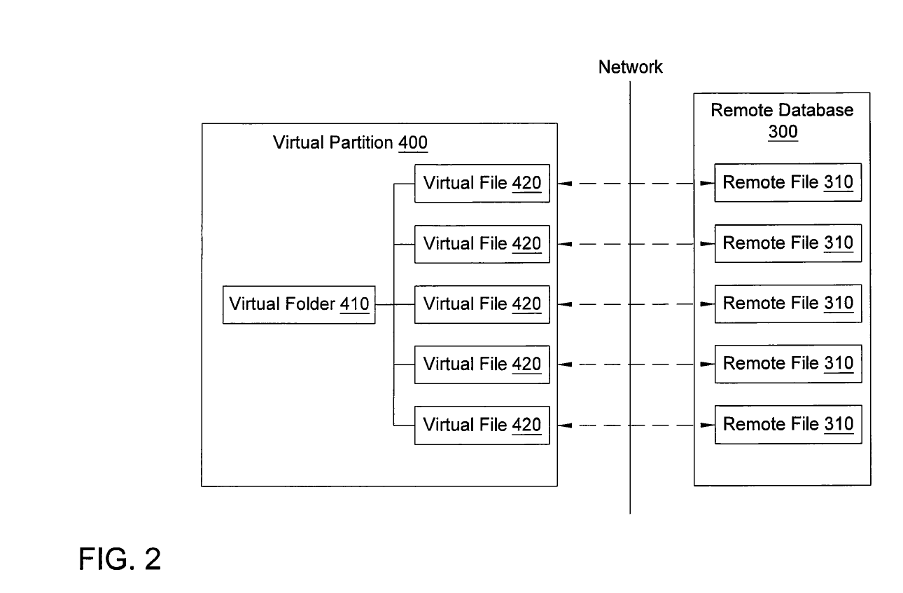

Referring to FIGS. 1 and 2, a wireless virtual storage apparatus 100 an embodiment according to the present invention is shown. The wireless virtual storage apparatus 100 is connected to a removable storage media reader 210 of a multimedia electronic device 200, and provides a virtual partition 400 mounted under the file system of the multimedia electronic device 200 for allowing the multimedia electronic device 200 to access remote files 310 stored in a remote database 300.

Referring to FIGS. 1 and 2, the wireless virtual storage apparatus 100 is connected to the remote database 300 after connecting to a network through a wireless access point. The network is the Internet and the remote database 300 is a FTP (file transfer protocol) server, Web server, or a similar internet accessed server. The network can also be a local area network (LAN) and the wireless virtual storage apparatus 100 is connected to a file-sharable computer used as the remote database 300 in the LAN. The wireless virtual storage apparatus 100 is connected to the remote database 300, for viewing the remote files 310 in the remote database 300, capturing a file list of one or more remote files 310. Next, the wireless virtual storage apparatus 100 creates virtual files 420 corresponding to the remote files 310 and creates a virtual partition 400. And the virtual files 420 are stored in the virtual partition 400. When the multimedia electronic device 200 sends an access request for accessing the virtual file 420, the wireless storage device 100 loads the corresponding remote file 310 from the remote database 300, allowing the multimedia electronic device 200 to access the loaded remote file. The remote database 300 stores the access-authorized remote file 310 in a folder or a plurality of folders corresponding to a user account, and allows a client logging into the user account to access the remote file 310 corresponding to the user account in accordance with the login user account.

Referring to FIG. 1, a system block diagram of the wireless virtual storage apparatus 100 is shown. The wireless virtual storage apparatus 100 includes a system memory 110, a microprocessor 120, a bus interface 130 and a wireless network interface 140.

The system memory 110 may be a nonvolatile memory such as a flash memory, or a combination of nonvolatile and volatile memories. The system memory 110 is provided for storing a micro operating system, a file system program and drivers. The system memory 110 is also used as a buffer for a program execution or file access simultaneously. For example, if the system memory 110 is the combination of nonvolatile and volatile memories, the micro operating system, the file system program, and the drivers are stored in the nonvolatile memory, and the volatile memory, such as random access memory (RAM), is used as the buffer for the program execution or the file access.

Referring again to FIG. 1. The system memory 110 is connected to the microprocessor 120, allowing the microprocessor 120 to process data access. The microprocessor 120 loads the micro operating system to process booting and system initialization, and loads the file system program and the drivers, wherein the driver includes a bus interface driver and wireless network interface driver for the microprocessor 120 to drive the bus interface 130 and the wireless network interface 140.

The bus interface 130 is matched with the removable storage media reader 210 of the multimedia electronic device 200, and they are electrically connected to each other. Through the bus interface 130 and the removable storage media reader 210, the wireless virtual storage apparatus 100 is electrically to the multimedia electronic device 200 and the wireless virtual storage apparatus 100 becomes a removable disk of the multimedia electronic device 200, and then the multimedia electronic device 200 initializes and mount the wireless virtual storage apparatus 100. The removable storage media reader 210 of the multimedia electronic device 200 may be a universal serial bus, secure digital (SD) card reader, or compact flash (CF) card reader. And the bus interface 130 of the wireless virtual storage apparatus 100 is matched with the aforementioned bus or readers, that is, a protocol adopted by the bus interface 130 is a universal serial bus protocol, a secure digital protocol, or compact flash protocol, and a corresponding electric connector is provided for interface bus 130 being connected to the removable storage media reader 210.

As mentioned above, the bus interface 130 is electrically connected to the removable storage media reader 210 of the multimedia electronic device 200 so as to connect the wireless virtual storage apparatus 100 to the multimedia electronic device 200. And the wireless virtual storage apparatus 100 provided the virtual partition 400 to be mounted by the multimedia electronic device 200. The bus interface 120 is also connected to a power pin and a ground pin of the removable storage media reader 210 to obtain the power required for the operation of the wireless virtual storage apparatus 100 and process the ground of a system circuit. If the voltage or power supplied by the removable storage media reader 210 is insufficient to the wireless virtual storage apparatus 100, the wireless virtual storage apparatus 100 may also obtain power required for the operation from an external power source or battery through an independent power supply. The power supplied by the removable storage media reader 210 can trigger the microprocessor 120 of the wireless virtual storage apparatus 100 to start processing booting and system initialization, and then the wireless virtual storage apparatus 100 loads the file system program and the drivers. After being enabled by the microprocessor 120, the wireless network interface 140 searches a wireless access point and uses a wireless network protocol to login the wireless access point to connect to a network such as LAN, Internet, and the like. The wireless communication technology adopted by the wireless network interface 140 is not limited to a Wireless Fidelity (WiFi) communication technology, the wireless communication technology adopted may also be a General Packet Radio Service (GPRS), Global System for Mobile communications (GSM), third Generation (3G) mobile communication system, 3.5th generation (3.5G) mobile communication system, or Worldwide Interoperability for Microwave Access (WiMAX).

The driver of the bus interface 130 is executed at the same time to enable the bus interface 130 to communicate with the removable storage media reader 210 of the multimedia electronic device 200, in accordance with the handshake authentication of a removable storage media and the protocol of the removable storage media reader 210 to allow the multimedia electronic device 200 to recognize the wireless virtual storage apparatus 100 as a removable storage media and search an accessible partition to process the mounting.

By running the file system program, the microprocessor 120 loads a preset login profile and then creates a corresponding virtual folder 410. The microprocessor 120 also creates the virtual partition 400 in the system memory 110 and stores the virtual folder 410 in the virtual partition 400. The virtual partition 400 is a physical volume of the system memory 110 or an image file stored in the system memory 110. Through the handshake authentication of a removable storage media, the multimedia electronic device 200 recognizes the virtual partition 400 as a physical volume in a removable storage media, and then mounts virtual partition 400.

The login profile records the protocol for accessing the remote database 300, the data structure of the remote database 300, the network address of the remote database 300, and a corresponding login identification data for accessing the remote database 300. Thereby, by running the file system program, the login profile allows the wireless virtual storage apparatus 100 to connect the remote database 300 a correct protocol and to log in the remote database 300 with correct login identification data. Herein, the login identification data usually includes a user account and login password.

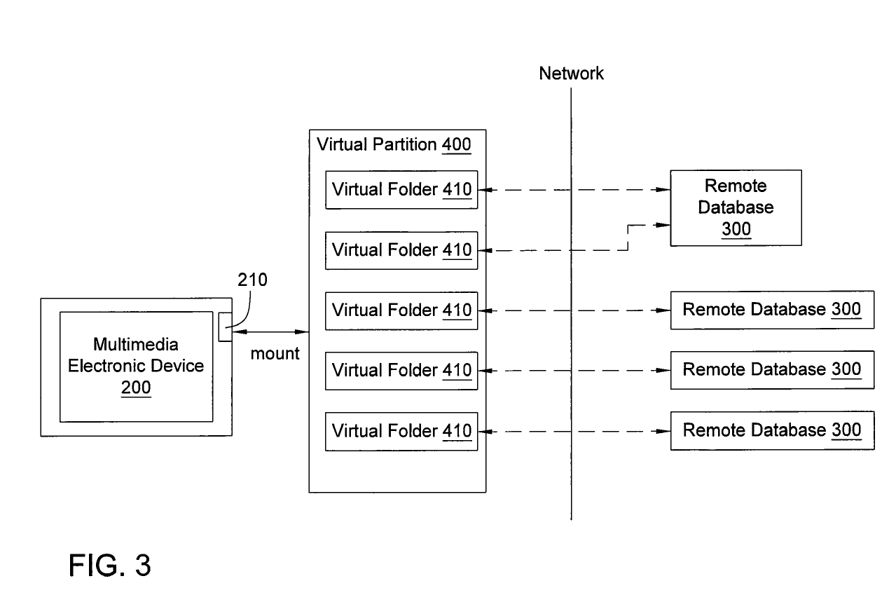

Referring to FIG. 3. The processor 120 running the file system program may load a plurality of login profiles at the same time, and creates a plurality of corresponding virtual folders 410 stored in the virtual partition 400. Each virtual folder 410 represents a different remote access. These remote accesses may be different remote databases 300. These remote accesses may be the same remote database 300 but logging in with different the login identification data. For example, a Web server providing Web albums accepts the logins of numerous users at the same time, each user is connected to the same Web server, but the user accesses the remote file 310 under a different file path in accordance with a login identification data difference. Therefore, the present invention may also set the same remote database in different login profiles, but set different login identification data in each login profiles, allowing a plurality of virtual folders 410 to correspond to the same remote database 300, but the accessed remote file 310 is different.

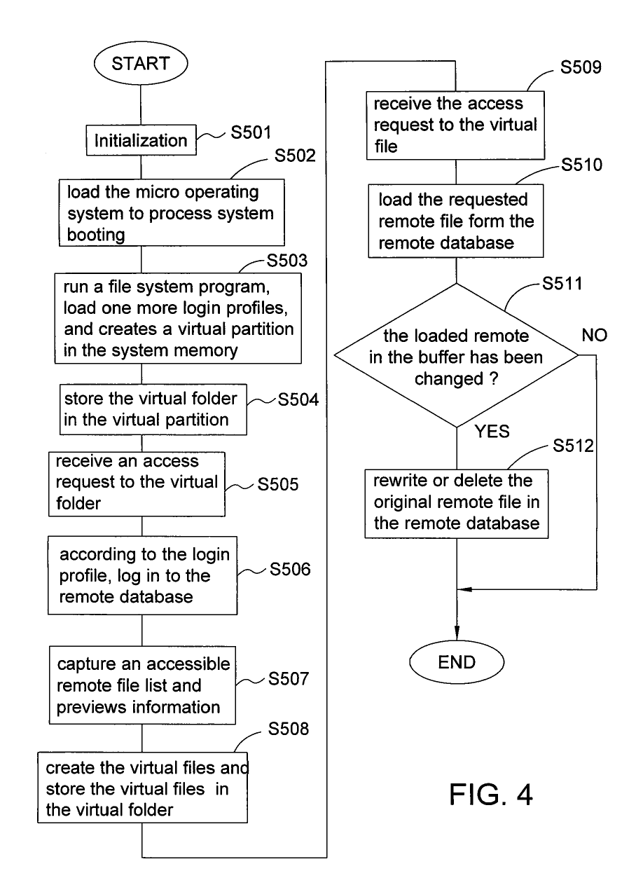

Referring to FIG. 4, a flow chart of a method of the present invention is shown. After the wireless virtual storage apparatus 100 connects the multimedia electronic device 200 and is activated, the microprocessor 120 processes hardware initialization (S501). Then the microprocessor 120 loads the micro operating system to process system booting (S502). The wireless virtual storage apparatus 100 may be activated manually, such as pushing a button or using a switch of the wireless virtual storage apparatus 100. Or the wireless virtual storage apparatus 100 may be activated automatically, when the bus interface 130 of the wireless virtual storage apparatus 100 is connected to the removable storage media reader 210 and the wireless virtual storage apparatus 100 is powered by the removable storage media reader 210 of the multimedia electronic device 200, the electronic power triggers the wireless virtual storage apparatus 100, and the wireless virtual storage apparatus 100 is activated automatically. After the system booting is completed, the microprocessor 120 runs a file system program, loads one more login profiles, and creates a virtual partition 400 in the system memory 110 (S503). Then, the microprocessor 120 stores the virtual folder 410 in the virtual partition 400 (S504).

When the multimedia electronic device 200 accesses the virtual folder 410 in accordance with a user's operation, the microprocessor 120 receives an access request to the virtual folder 410 from the multimedia electronic device 200 (S505). According to the login profile corresponding to the virtual folder 410, the microprocessor 120 logs in to the remote database with the login identification data of a login profile in accordance with the login profile (S506). Then, the microprocessor 120 captures an accessible remote file list and preview information of the remote files 310 (S507), and creates the corresponding virtual files 420 and stores the virtual files 420 in the virtual folder 410 of the virtual partition 400 (S508). The aforementioned steps are to allow the multimedia electronic device 200 to obtain the list of the remote files 310 and the preview information which can be accessed by login with the login profile.

When the multimedia electronic device 200 further sends a access request to the virtual file 420, the microprocessor 120 receives the access request to the virtual file 420 from the multimedia electronic device 200 (S509), and then the microprocessor running the file system program send an access request to the remote database 300 to load the requested remote file 310 form the remote database 300 through a network and stores the remote file 310 in a buffer of the system memory 110 (S510). Then, the microprocessor 120 changes the file accessing path of the multimedia electronic device 200 toward the loaded remote file 310 stored in the buffer to answer the access request of the multimedia electronic device 200. The multimedia electronic device 200 loads and executes the remote file 310 using a corresponding multimedia program in accordance with a data file format. If a user account in the login profile has authority to write or delete files, the microprocessor 120 then determines whether the loaded remote 310 in the buffer has been changed by the multimedia electronic 200 (S511). If the loaded remote file 310 is changed, the microprocessor 120 running the file system program uploads the changed remote file to the remote database 300 to rewrite or delete the original remote file 310 in the remote database 300 (S512). The aforementioned user account is used to determine which of the remote files 310 may be accessed, and to control access authority to each remote file 310 after a user-login of the remote database 300. Naturally, an anonymous login or guest login may also be used, but the accessed files and the access authority are far more restricted.

Taking a digital photo frame as an example, the digital photo frame has a simple embedded operating system to play specifically formatted pictures or audio video files. A file displayed by the digital photo frame is stored in a built-in storage memory via a data transmission interface, or loaded from a removable storage media such as a SD card, CF card, USB flash disk, or memory stick through the removable storage media reader. However, neither the hardware nor the software of the digital photo frame is expansible; files outside the digital photo frame have to be accessed through the replacement of the removable storage media.

The wireless virtual storage apparatus of the present invention creates a virtual partition mounted by the digital photo frame after being connected to the removable storage media reader of the digital photo frame. To the multimedia electronic device, the virtual partition is the same as a physical volume provided by a general removable storage media, and the virtual partition can be directly mounted by the digital photo frame through the removable storage media reader. A plurality of virtual folders corresponding to different remote databases is created in the virtual partition, wherein the remote database may be a FTP server, Web server or a computer in LAN. Therefore, the digital photo frame may not only display local picture files (sorted in built-in memory or removable storage media), but may also access picture files from a remote database. To the digital photo frame, the access is processed in the virtual partition mounted locally; it is not an action of connecting to a network. Such that modification to the hardware and software resources of the digital photo frame are not required. All actions such as connecting to the network, obtaining remote file list, and accessing remote files are processed through the wireless virtual storage apparatus.

As mentioned above, different protocols have to be used for connecting to different remote databases. Therefore, a protocol to be used has to be set in the login profile, so as to connect to the different remote database 300. Connection to a simple remote database 300 such as a server adopting FTP or HTTP protocol, only a protocol, network address, and login identification data (user account and login password), are required in the login profile. The microprocessor 120 running the file system program can then send an accessing request in accordance with this information, and then send the user account and login password in sequence to login and obtain the necessary access authority after the remote database 300 answers the request. However, many database servers do not allow remote users to obtain access authority of specific folders directly, but provide a login page of Hyper Text Markup Language (HTML) through HTTP protocol, for example, a free Web album. A user of the database server such as Web album has to use a Web-Browser to visit the login page to log in, and then further browse the pages with browsing authority. But, the information of these pages can only provide a file link or file information (resized picture of relatively worse size and quality). In addition, the aforementioned file link usually is not exactly a true file accessing path, and it is necessary to execute a script to send out a request to a database, so the database can then reply providing a true file accessing path to allow a user to download the file to a temporary folder in the Web-Browser, and carry out online reading through the Web-Browser after clicking a button representing a specific file on the page.

Using a database system such as the aforementioned Web album from which file folder browsing authority cannot be obtained directly, a login script has to be used in accordance with the database system. A simpler way is to use an application programming interface (API) written in accordance with the database system, allowing it to be a direct interface between the file system program and the database system, enabling the file system program to obtain a file list and a true file accessing path of the remote file. However, the API has to be provided by a database system administrator, and not all administrators are willing to provide the API.

The login script should be written in accordance with a page layout to allow the file system program to discover which fields need to be filled with the user account and the login password in the login page, then the user account and the login password is filled in, and a request is sent out to wait for the mainframe's response. It is then necessary to search for the link of the photo so as to display a file list and search for the true route of the photo, or send out a request to ask the mainframe to return the true file accessing path in order to load the remote file in the buffer in accordance with the page layout, after obtaining browsing authority.

In addition, a tool program designed in accordance with a specific operation system, used for providing a graphic user interface (GUI) to allow a user to edit each login profile quickly through the filling and the correction of the fields, may be stored in the system memory 110. For example, compile the tool program in accordance with a personal computer operating system. The tool program can be executed when the wireless virtual storage apparatus is connected to a personal computer. In addition, it is not accidentally executed by the multimedia electronic device. A simple Web page server module may be added in the micro operating system to allow the personal computer to be connected to the set page through a Web-Browser and to process the correction of the login profile.

Additional advantages and modifications will readily occur to those skilled in the art. Therefore, the invention in its broader aspects is not limited to the specific details and representative embodiments shown and described herein. Accordingly, various modifications may be made without departing from the scope of the general inventive concept as defined by the appended claims and their equivalents.

What is claimed is:

1. A wireless virtual storage apparatus, connecting to a removable storage media reader of a multimedia electronic device, for the multimedia electronic device accessing at least one remote file in a remote database through a network, the wireless virtual storage apparatus comprising:
a wireless network interface, using a wireless network protocol to connect to the remote database via the network;
a microprocessor, running a file system program, logging in the remote database through the wireless network interface, creating a virtual file corresponding to the remote file, and creating a virtual partition to store the virtual file; and
a bus interface, connected to the microprocessor and a removable storage media reader of the multimedia electronic device, allowing the multimedia electronic device to mount the virtual partition to access the virtual file;
wherein, the wireless virtual storage apparatus is arranged such that when the multimedia electronic device accesses the virtual file, the microprocessor loads the corresponding remote file from the remote database and change an accessing path of the multimedia electronic device to the loaded remote file.

2. The wireless virtual storage apparatus as claimed in claim 1, further comprising a system memory connected to the microprocessor for storing the file system program and for the virtual partition to be created in the system memory.

3. The wireless virtual storage apparatus as claimed in claim 2, wherein the system memory stores a bus interface driver and a wireless network interface driver for the microprocessor driving the bus interface and the wireless network interface.

4. The wireless virtual storage apparatus as claimed in claim 1, wherein a protocol adopted by the bus interface is selected from the group consisting of a universal serial bus, a secure digital protocol, and compact flash protocol.

5. The wireless virtual storage apparatus as claimed in claim 1, wherein the file system program loads a login profile and generates a corresponding virtual folder stored in the virtual partition, and the virtual file is stored in the virtual folder.

6. The wireless virtual storage apparatus as claimed in claim 5, wherein the login profile includes a protocol for accessing the remote database, a data structure of the remote database, a network address of the remote database, and a login identification data for accessing the remote database, thereby allowing wireless virtual storage apparatus running the file system program to log in the remote database.

7. The wireless virtual storage apparatus as claimed in claim 6, wherein the login identification data includes a user account and a corresponding login password.

8. A remote file accessing method, for a multimedia electronic device using a removable storage media reader to access at least one remote file stored in a remote database via a network, the method comprising the steps of:
connecting the multimedia electronic device;
loading at least one login profile, and creating a virtual folder corresponding to the login profile;
creating a virtual partition, and storing the virtual folder in the virtual partition;
receiving an access request to the virtual folder from the multimedia electronic device, logging in to the remote database in accordance with the login profile, capturing an accessible remote file list, and creating a virtual file corresponding to the remote file in the virtual partition; and
receiving the access request to the virtual file from the multimedia electronic device, loading the remote file through a network, storing the remote file in a buffer, and changing an accessing path of the multimedia electronic device toward the loaded remote file stored in the buffer to answer the access request of the multimedia electronic device.

9. The remote file accessing method as claimed in claim 8, further comprising steps of:
determining whether the loaded remote file in the buffer has been changed;
rewriting the change to the original remote file in the remote database when the loaded remote file in the buffer has been changed.

10. A remote file accessing method, for a multimedia electronic device using a removable storage media reader to access remote files in a plurality of remote databases via a network, the method comprising the steps of:
connecting the multimedia electronic device;
loading a plurality of login profiles respectively corresponding to each remote database, and creating a plurality of virtual folders respectively corresponding to each login profile;
creating a virtual partition, and storing the virtual folders in the virtual partition;
receiving an access request to one of the virtual folders from the multimedia electronic device, logging in to the corresponding remote database in accordance with the login profile, capturing an accessible remote file list, and creating virtual files corresponding to the remote files in the virtual partition; and
receiving the access request to one of the virtual file from the multimedia electronic device, loading the corresponding remote file through a network, storing the loaded remote file in a buffer, and changing an accessing path of the multimedia electronic device toward the loaded remote file stored in the buffer to answer the access request of the multimedia electronic device.

11. The remote file accessing method as claimed in claim 10, further comprising steps of:
determining whether the loaded remote file in the buffer has been changed;
rewriting the change to the original remote file in the remote database when the loaded remote file in the buffer has been changed.
